(19) United States
(12) Patent Application Publication
(10) Pub. No.: US 2006/0026041 A1
(43) Pub. Date: Feb. 2, 2006

(54) System and method for managing a prescription drug savings plan

(76) Inventor: Richard Ullman, Wayne, NJ (US)

Correspondence Address: MILBANK, TWEED, HADLEY & MCCLOY, 1 CHASE MANHATTAN PLAZA, NEW YORK, NY, 10005-1413, US

(21) Appl. No.: 10/901,337

(22) Filed: Jul. 28, 2004

(51) Int. Cl. G06F 19/00

(52) U.S. Cl. 705/3; 705/14

(57) ABSTRACT

Patient prescription savings are maintained in an account, with manufacturer rebates applied to the account. When a prescription is processed, benefit carrier contribution is determined. Contra-indications for the prescribed drug are also identified and when so identified an alert is provided to the pharmacy.

### BACKGROUND

1. Field of the Invention

The invention relates to the field of prescription drug expenditures and a series of processes to earn monetary premiums to reduce or share the earnings through a customer, pharmacy, merchant, and bank facilitated credit card, debit card, stored value card, savings plan. More specifically, it is directed to the field of prescription drug savings plans for a patient's full payment, their coinsurance share, any plan exclusions or prescriptions for their family pets.

2. Description of the Related Art

Credit card bonus programs, customer loyalty reward programs, and discount programs are known in the art. Similarly, insurance benefits carriers for prescription drug programs, and drug rebate programs are also known in the art.

Systems and methods are needed that combine certain features of these known systems with new features to provide capabilities that are not presently available.

The preceding description is not to be construed as an admission that any of the description is prior art relative to the present invention.

### SUMMARY OF THE INVENTION

In one embodiment, the invention provides a system and method for managing a patient's prescription drug savings account, which comprises receiving information related to a patient's prescription transaction, to include the information regarding the prescribed drug. The system and method identify numerous data fields including the contra-indication for the prescribed drug using information from at least one historical patient prescription transaction; provide an alert based on the contra-indication; and adjust the patient prescription drug savings account balance using the information related to the patient prescription transaction.

In another embodiment, the invention provides a system and method for managing a patient prescription drug savings account, which comprises receiving information related to a patient prescription transaction, the information including transaction cost and prescribed drug information. The system and method further comprise sending patient identification information and the prescribed drug information to a benefits carrier; receiving co-payment information from the benefits carrier, the co-payment information including a covered amount; calculating a remaining amount owed using the transaction cost and the co-payment information; calculating a savings account adjustment using the remaining amount owed; and adjusting the patient prescription drug savings account balance using the calculated adjustment.

In another embodiment, the invention provides a system and method for managing patient prescription drug savings accounts, which comprises issuing a patient prescription drug product card, the product card having an associated patient prescription drug savings account. The system and method further comprise receiving information related to a patient prescription transaction, the information including prescribed drug information and product card information; identifying a first patient's prescription drug savings account using the product card information; adjusting the first patient prescription drug saving's account balance using the information related to the patient prescription transaction; and transferring a portion of the first patient prescription drug savings account balance to a second patient prescription drug savings account balance.

In another embodiment, the invention provides a system and method for managing a patient prescription drug savings account which allows tax-free medical savings account money to be transferred or deposited into the account.

The specific objects and advantages of the invention described herein are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an example system according to an embodiment of the invention;

FIG. 2 illustrates steps in an example method according to an embodiment of the invention;

FIG. 3 illustrates steps in an example method according to an embodiment of the invention;

FIG. 4 illustrates steps in an example method according to an embodiment of the invention;

FIG. 5 illustrates steps in an example method according to an embodiment of the invention;

FIG. 6 illustrates steps in an example method according to an embodiment of the invention;

FIG. 7 illustrates steps in an example method according to an embodiment of the invention; and

FIG. 8 illustrates steps in an example method according to an embodiment of the invention.

It is understood that the drawings are for illustration only and are not limiting.

### DETAILED DESCRIPTION OF THE DRAWINGS

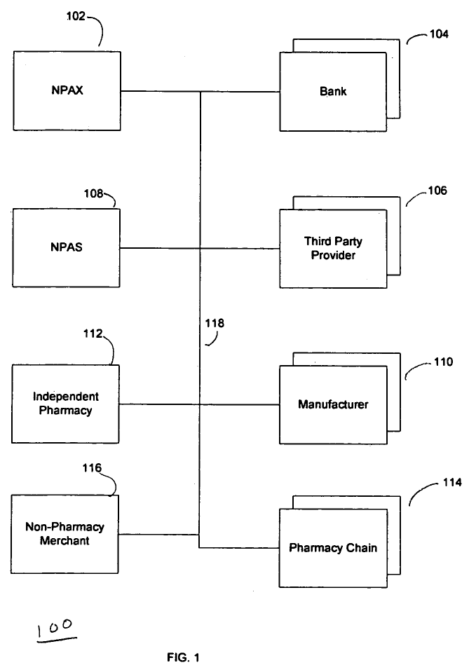

Referring to FIG. 1, system 100 includes prescription savings coordinator 102, bank or financial party 104, third party benefit management providers 106, provider access service 108, participating manufacturers 110, and participating pharmacies 112, 114, and non-pharmacy merchants 116, interconnected by network 118. In the description that follows, NPAX is the name of the prescription savings facilitator and coordinator 102. However use of the term NPAX is only an example and is not limiting. Participating pharmacy 112 is typically an independent or small pharmacy. Participating pharmacy 114 is typically a pharmacy chain or mail order pharmacy. Network 118 may be the Internet, a local area network, a wide area network, or the public switched telephone network with electronic connections using modems.

Prescription savings coordinator 102, bank 104, third party benefits providers 106, provider access service 108, participating manufacturers 110, and participating pharmacies 112, 114 have a computer or computers with processor, memory, data storage, code storage, display, input and output devices, and network interface devices.

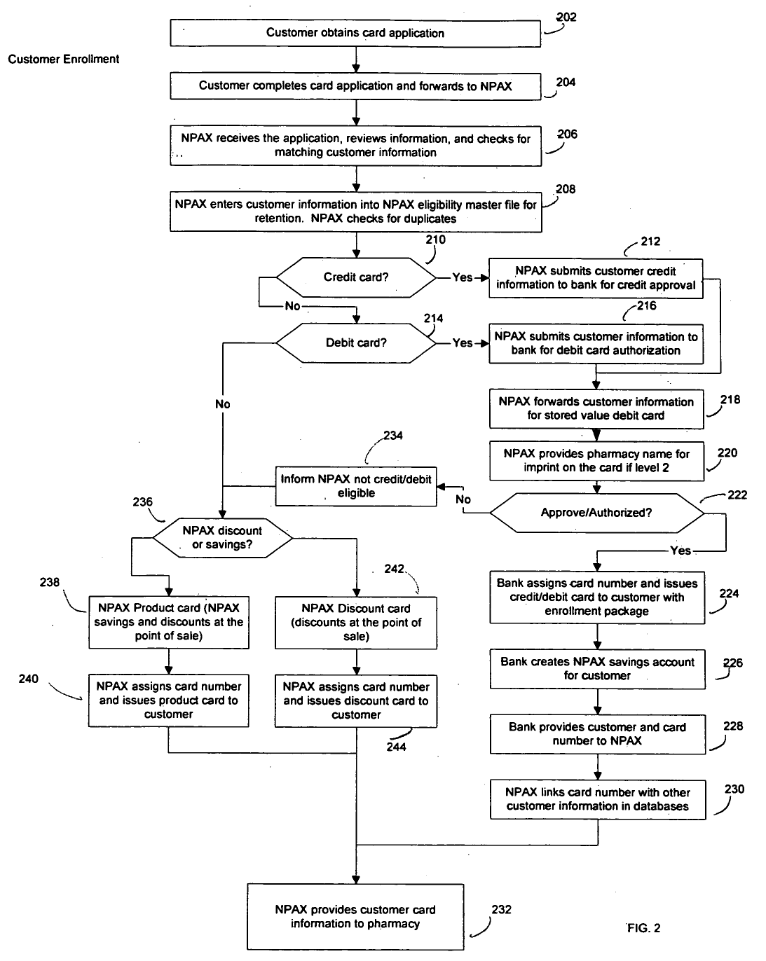

Referring to FIG. 2, at step 201, a customer obtains an NPAX card application. Customers generally get NPAX card applications at a participating pharmacy, health care practitioner's office, the internet via the NPAX web-site or other affiliate link, or they may be provided or available through another source, such as through the customer employer, direct mail or another non-pharmacy location. When an NPAX participating pharmacy provides the card application, then the pharmacy typically pre-prints their name and/or National Association of Boards of Pharmacy (NABP) number on the card application so that NPAX can correlate the particular participating pharmacy with the customer's card application. NPAX personnel can add the NABP number of the applicants preferred pharmacy indicated on applications acquired through non-pharmacy sources.

At step 202, a customer completes an NPAX card application and forwards the application to NPAX. As described elsewhere in greater detail, some of the application information covers the type of NPAX savings account (use, save or transfer) that the customer initially wants to establish. Additionally, if the customer has a third party benefits carrier, that information is generally included on the application. Alternatively, it may be provided to NPAX at a later time, or already known to NPAX from earlier transactions or from the customer's employer. The customer also signs a release allowing NPAX to use the data to obtain money or other value for their prescription claim payments. The customer signature also satisfies any banking card requirements.

At step 206, NPAX receives the completed card application from the customer, and reviews the information.

At step 208, NPAX enters customer information into an NPAX eligibility master file for retention. NPAX checks for duplicate submissions, and may also check for matching information on the customer, such as from an employer who has provided a list of employees and associated benefits carrier information.

At step 210, NPAX determines whether the card application is for a credit card, and if so, at step 212 NPAX forwards the customer application information to the bank for credit approval.

If the card application is not for a credit application, then at step 214, NPAX checks to see if the card application is for a debit card, and if so, at step 216 NPAX forwards the customer application to the bank for debit card authorization.

At step 218, NPAX forwards the customer information for a stored value debit card. In addition, the monetary payments for the stored value card are deposited in the NPAX Customer claims Payment Account for use at the time the prescriptions is dispensed. The stored value amount is reduced by the prescription cost. In addition to forwarding the customer information, at step 220, NPAX may also send additional information to the bank, such as the name of the participating pharmacy. This can be particularly appropriate where the participating pharmacy name will be printed on the face of the card. At step 220, NPAX also provides the bank with the savings program type that the customer has selected, such as accrue/save, use/spend or transfer/second NPAX designee. These different savings program types are described elsewhere in greater detail.

At step 222, the bank reviews the customer application information and makes a decision regarding approval or authorization of the respective credit or debit card application.

If the application is approved/authorized, then at step 224, the bank assigns a card number to the customer and then forwards the respective credit/debit card to the customer with an enrollment package. Typically, the first four digits of the card number serve to identify the card as an NPAX credit, debit card or stored value card.

At step 226, the bank creates an NPAX customer savings account system that tracks the savings balance earned and redeemed under the program guidelines.

There are a number of different types of credit, debit cards, and stored value cards that the bank may issue on behalf of NPAX, the designated vendor, or a pharmaceutical manufacturer. One is a card that identifies the issuing bank and NPAX on the card face. Another is a card that identifies the issuing bank, NPAX and the name of the participating/sponsoring pharmacy. Another is a card that shows the pharmaceutical manufacturer, vendor and NPAX designation.

If not done in an earlier step, then at step 228, the issuing bank provides the assigned customer number to NPAX along with the associated customer name. This allows NPAX to update their databases at step 230 extracting dependent and demographic data entered initially into the NPAX applications systems and combining this with the newly assigned credit, debit or stored value card number provided by bank.

After providing the card to the customer, at step 232, the bank or NPAX may provide the card number to the pharmacy.

If at step 222 the bank determines that the customer is not approved for a credit card or authorized for a debit card, then at step 234, the bank informs NPAX. This allows NPAX to offer the customer another type of card. As further discussed below, those other types of cards might include discount and/or savings cards.

If at step 214, NPAX determines that the customer application is not for a debit card, then at step 236, NPAX determines whether the customer application is for a product card or for an NPAX discount card.

If the application is for a product card, then at steps 238 and 240, NPAX assigns a card number to the customer, opens or creates the customer savings account, and issues the card to the customer. A customer can use an NPAX product card at the point of sale and receive immediate discounts, but in addition to point-of sale discounts, this card provides the customer with an accruing savings account. Depending on how the customer has established their account, they can also use value from their savings account at the point of sale. As an example, the monetary value added to the savings account might come from employer contributions, governmental agencies, associations, NPAX customer transfers, medical savings accounts, other NPAX earned transfers, pharmaceutical and general product manufacturer dollars, or merchant contributions and coupon processes. These features are described elsewhere in greater detail.

If the application is for a discount card, then at steps 242 and 244, NPAX assigns a card number to the customer. A customer can use an NPAX discount card at the point of sale for discounts, but the card is generally not tied to an accruing savings plan that is maintained by NPAX. NPAX will maintain processes where premiums will be provided from prescription historical card usage or transfers from other designated accruing customer accounts.

After providing the card to the customer, at step 232, NPAX may provide the customer product or discount card number to the pharmacy.

Although not illustrated in FIG. 2, a customer may be enrolled as a cash payer, a third party PBM payer, a cash payer for co-payments, and as a cash payer who submits its insurance claims. That payer information may be provided by the customer when they apply for the card, or it may be added by NPAX from a database with customer information after receiving the customer's card application. The participating pharmacy may use the NPAX system as a pharmacy charge card within the store.

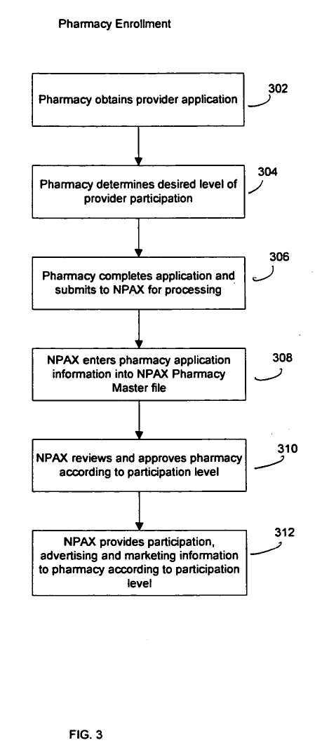

Referring to FIG. 3, a pharmacy may enroll in the program after contact with NPAX. In the pharmacy enrollment process at step 302, a pharmacy obtains a provider application, typically from NPAX. At step 304, the pharmacy determines the desired level of participation. It is envisioned that there are multiple participation levels, such as:

Level I—Participatory Pharmacy

This level of participation is basic. All pharmacies with an NABP number are considered to be in the NPAX network. They are provided an “NPAX Plan Description” over the internet either in downloadable format from the NPAX web-site or sent via email. Internet enrollment allows for immediate network participation. Unless the pharmacy notifies NPAX that they wish not to participate, they are considered providers. The pharmacy should accept the card for dispensed Rx pharmaceutical items and submit the claim parameters to NPAX to adjudicate the claim and simultaneously send the cash portion on to a bank for credit/debit verification and processing. This transaction typically results in a monetary contribution to the customers NPAX prescription savings account. Prescription transactions are submitted from the pharmacy computer to NPAX and generally do not follow the standard credit card swipe submission procedures.

Level II—Preferred Participatory Pharmacy

This level indicates a pharmacy that not only accepts but markets the card to their cash payors. These providers receive marketing kits and support from NPAX relating to advertising the product as well as their pharmacy. The pharmacy also gains the ability to charge and bill for pharmacy purchases without the handling of additional paperwork, have their pharmacy name printed directly on the face of the credit/debit card and stored value card, making the card a unique tri-brand and allowing the pharmacy the opportunity to compete with larger competitors. This level of participation typically requires an annual fee be paid to NPAX by the pharmacy to acquire these benefits/opportunities.

Level III—Preferred Participatory Merchant Pharmacy

In addition to what was previously outlined for Level II, this level of provider also offers customers the opportunity to earn additional savings dollars from purchases made at their pharmacy or for certain products purchased at their pharmacy. They are both a preferred pharmacy and a preferred merchant.

At step 306, the pharmacy completes the application and submits it to NPAX for processing.

At step 308, NPAX enters the pharmacy application information submitted via the internet into the NPAX Pharmacy Master file. This may include name, address, city, names of pharmacists, discount, etc.

At step 310, NPAX approves participation status according to the participation level.

At step 312, NPAX provides the pharmacy with enrollment, advertising, marketing and other materials according to the participation level.

Manufacturers may also contribute funds, which can be applied to a customer savings account. Funds may be used towards the cost of any prescription item or segregated from other earnings to be redeemed only on specific prescription items. Although not illustrated, there may be an enrollment process with NPAX for those manufacturers.

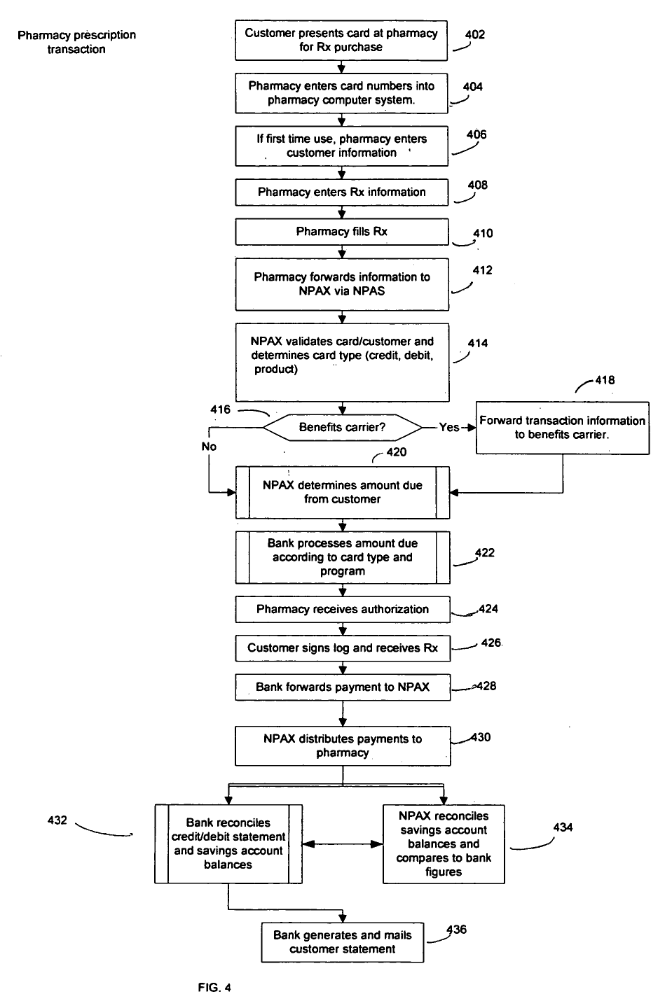

Referring to FIG. 4, a typical prescription transaction at a pharmacy begins at step 402 with the customer presenting their card and prescription at the pharmacy. In this example, the card is a credit a debit or a stored value card, and this is the first time that the customer has used the card at this particular pharmacy.

At step 404, the pharmacy enters the card numbers from the card to enroll the customer into the pharmacy computer system.

At step 406, if this is the first time that the customer has been to the pharmacy or used the card at the pharmacy, the pharmacy enters customer information, (e.g., date of birth, address, phone number).

At step 408, the pharmacy enters prescription information, (e.g., drug and quantity), and at step 410, the pharmacy fills the prescription.

At step 412, the pharmacy forwards the prescription information, the customer information and the card numbers over the National Provider Access System (NPAS), or other routing media services that connects to NPAX. An immediate or sub-second authorization or denial response is forwarded back to the pharmacy by means of the NPAX connection service or the internet.

At step 414, NPAX validates the customer card number information and any other benefit carrier information.

At step 416, NPAX determines whether the customer has a benefits carrier, and if so, sends the information required by the benefits carrier for processing their share of the payment at step 418. That information includes the drug type and customer information.

At step 418, the benefits carrier determines whether the drug is covered by the plan and the amount of any out-of pocket expenses due from the customer, such as any deductible or co-payment due from the customer.

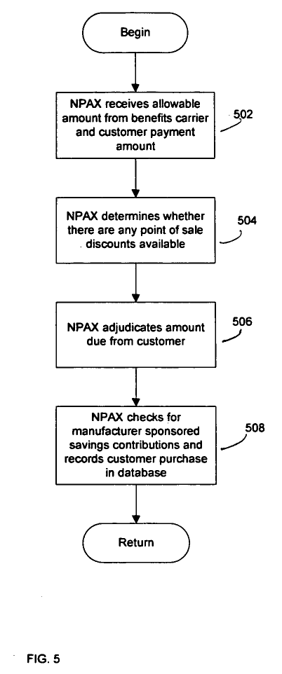

At step 420, NPAX determines the amount due from the customer. If there is a benefits carrier, there will be an authorized amount and there may be an amount due from the customer such as a co-payment and/or deductible. This is an adjudication process. If there is no benefits carrier, or it is an exclusion and an obligation of the customer, the amount due may be the full amount of the prescription, or it might be a discounted amount. Step 420 is further illustrated in FIG. 5.

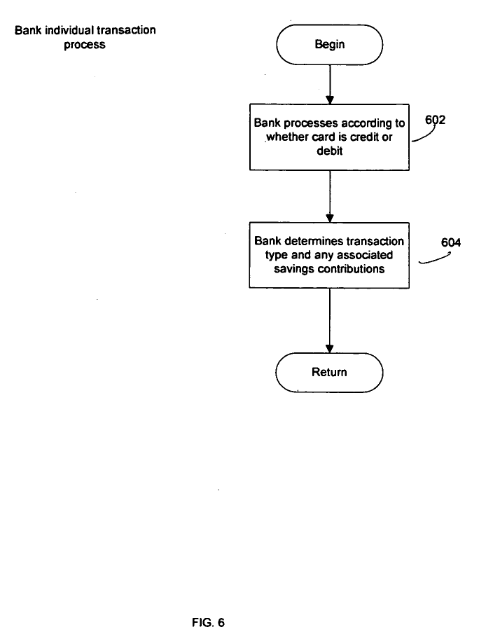

At step 422, NPAX sends the required information to the bank for processing according to the card type and program. Typically, this means that NPAX processes a debit card one way, processes a credit card another way, and processes a stored value card another way. The processing at step 422 is further illustrated in FIG. 6.

When NPAX receives the information at step 412, it includes the type of prescription medication. For each patient, NPAX maintains a database of all medications that have been prescribed and purchased, and the medication for the current prescription is compared to the other medications that are stored in the database to identify any contra-indications. This typically involves checking previous prescriptions for the patient and a database of known contra-indications for the current drug. If there is a contra-indication, NPAX makes a record in the database of the contra-indication, and also sends a notice or warning to the pharmacy along with the authorization at step 424.

Most pharmacies keep a record of previous prescriptions for a patient and can therefore identify contra-indications based on their own records. However, where a patient uses multiple pharmacies, identifying contra-indications may be difficult. Using the invention, patients can use their card at multiple pharmacies and NPAX is in a unique position to identify contra-indications for prescriptions filled by multiple pharmacies. Of course, that capability also exists with NPAX when a patient uses a single pharmacy.

At step 424, the pharmacy receives authorization, and at step 426, the customer signs a log and receives the prescription.

In a later transaction, the bank forwards payment to NPAX at step 428, possibly each night, and NPAX forwards the payment to the pharmacy at step 430.

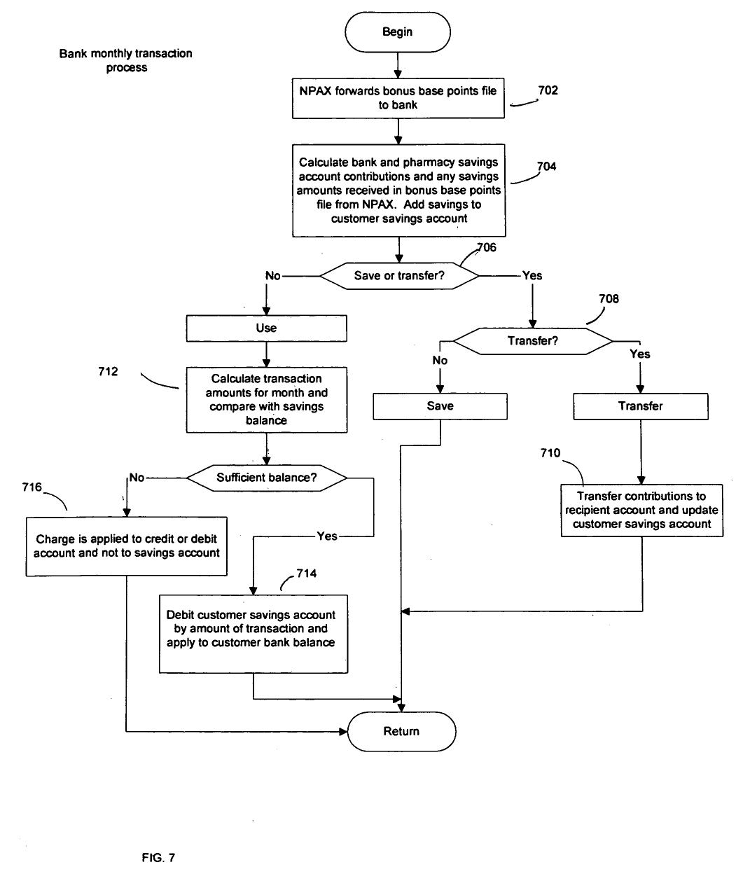

Both the bank and NPAX reconcile the customer savings account balances at steps 432 and 434 respectively. The reconciliation at steps 432 and 434 is typically done on a daily basis with a full reconciliation performed on a monthly basis, prior to the preparation of the customer's monthly bank statement. At step 436, the bank provides the customer a statement, and the customer pays the bill. The process of reconciling the savings accounts at step 432 is further illustrated in FIG. 7.

When the customer has a credit or debit card, the bank calculates the savings account balance and provides that balance in the monthly statement to the customer. For the product card, the bank is not involved and therefore NPAX maintains the account, performs a periodic reconciliation, and provides a statement or other indication of balance to the customer.

Although not fully illustrated, during various transactions NPAX and the bank collect or process information. At the time of processing, some of that information is known to both NPAX and the bank. Other information is known only to NPAX or the bank. During the reconcile process, which typically occurs monthly, some of the information that is known by only NPAX or the bank, is provided to the other party. For example, based on prescriptions for a particular drug, NPAX may receive manufacturer drug rebates or contributions. The amounts of those rebates or contributions are not generally known to the bank, and the proper allocation to particular customers is also unknown to the bank. However, that information is known to NPAX based on information that was provided with each prescription transaction. Accordingly, as part of the reconciliation process NPAX provides a data file to the bank that contains savings account numbers with associated manufacturer contribution amounts. That data file helps the bank reconcile the account each month.

Similarly, there is transaction information known to the bank, but not NPAX that is shared periodically. For example, savings account contributions based on general merchant purchases are known to the bank, but not to NPAX. Therefore, the bank provides a data file to NPAX that contains that information, so NPAX can update and maintain their records. There are other such files that are periodically exchanged between the bank and NPAX.

Referring to FIG. 5, the sale transaction by NPAX begins at step 502 with receipt of the allowable amount and the amount due from the customer from benefits carrier 106.

At step 504, NPAX determines whether there are any point of sale discounts available for the purchase. These discounts are not necessarily part of the savings plan, but are immediately available.

Any money or saving that is earned by the NPAX cardholder is deposited daily into the NPAX Customer Claims Payment account. At the same time the money is deposited it is also displayed in the cardholder's eligibility record. The accumulated funds in the account are available for the payment of prescription services in the manner directed by the cardholder (i.e. use, accrue or transfer).

For a User, the funds are applied and displayed on the statement as a line item. The funds reduce the cost of the applicable prescription purchased within the period since the previous statement production and listed as a description on the statement. They are applied as a credit or payment against the total amount due simultaneously. The money in the NPAX Customer Claims Payment account is drawn down and provided to the bank on the date the statements are mailed.

For an Accruer, the monetary amounts remain in the NPAX Customer Claims Payment account until the customer changes their status at NPAX from an accruer to a user or transferor.

For Accruer amounts retained in the account but dedicated to another person (e.g., Parent, loved one, friend), which can be termed a Transferor, the earned balances are displayed on each monthly bank statement with the money held in the NPAX Customer Claims Payment account. At the time of their bank statement generation, the useable money is deducted from the Transferors account even though the User customer statement is prepared on a different date of the statement month (e.g., 10^{th} vs. the 21^{st}). Whenever the using customer statement is prepared, the aforementioned user description prevails.

Monies earned by the use of the customer credit card are similarly deposited and used as described.

Pharmaceutical monetary rebates or promotional earnings are deposited periodically from contractual procedures where the data presented results from global usage with individual applications to the customer's account to protect confidentiality. The money remains in the account as an accruer, user or transferor until needed.

Pharmacy payments for prescriptions obtained through the cardholder's card are made by NPAX and listed on the check statement prepared on a scheduled basis (e.g., weekly) according to the contractual adjudication logic between NPAX and the pharmacy. The client presents their card and their prescription to the pharmacy. The pharmacy computer transmits all of the appropriate data to NPAX. NPAX accesses the customer's record to determine their payment, third party payment or a shared payment.

NPAX receives all of the prescription claims data but only sends the required information to the bank processor, the account number, the cardholder name, date and dollar amount to bank for application.

At step 506, NPAX adjudicates the amount due from the customer. At this step, NPAX will determine whether the customer has elected to use, accrue or transfer, and will also determine the type of customer card (credit, debit, discount or product). NPAX uses those determinations to adjudicate the amount due from the customer. Where the customer card is a discount or product card, there is generally no bank that is associated with the card to track and maintain the customer savings account balances. So, for those customers, NPAX maintains and reconciles the savings account balances and provides any customer statements.

At step 508, NPAX checks to see if there are any manufacturer savings contributions available. If so, NPAX records the customer purchase information in a database. Typically, a manufacturer will provide savings contributions as a reward for using their specific drug product or to learn about their customers, such as their demographics. NPAX gathers that information and provides it to the manufacturer in exchange for the manufacturer's savings contribution. NPAX keeps records of these manufacturer savings contributions because bank 104 does not typically know about these manufacturer savings contributions. NPAX gathers and maintains the manufacturer savings account balances of individual customers and then periodically sends that information to bank 104 as an electronic file.

Referring to FIG. 6, a bank transaction includes posting a charge to the credit card balance if the card is a credit card, or posting a debit from the customer account if the card is a debit card at step 602. At step 604, the bank also determines whether the transaction has associated savings contributions by the bank or others such as merchants, and determines the amount of that savings contribution.

The steps illustrated in FIGS. 5 and 6 occur at the time of the transaction. There are actions that the bank and NPAX perform on a periodic basis, typically each month prior to the statement date, where customer savings account information is reconciled with the charges. The steps performed by the bank are illustrated in FIG. 7.

The bank makes a contribution to the customer savings account based on the amount of the customer's purchases, and the bank also credits the customer savings account for other transactions. These amounts are typically a percentage of a purchase amount. Periodically, the bank and/or NPAX calculate the contribution by the bank to the customer savings account.

Referring now to FIG. 7, which illustrates the steps performed by the bank, the process begins at step 702 with NPAX forwarding any remaining Prescription Savings dollars information to the bank. This typically occurs periodically during the month and this step is performed to make a final update to the bank's data.

At step 704, the bank calculates any bank savings account contribution, along with any pharmacy savings account contribution. The bank is able to calculate this information by reference to the pharmacy information that is related to the customer card number, or it may have been provided by NPAX when the charge was send to the bank. Typically, those types of savings account contributions are added to the customer account balance before, Use, Save, or Transfer is performed.

For pharmacy transactions or purchases, the bank savings account contribution is generally about one (1) percent, and the pharmacy savings account contribution is generally from about two (2) up to about ten (10) percent.

For a general merchandise (non-pharmacy) transaction, there is generally no savings account contribution by a pharmacy, but there is generally the same bank savings account contribution of about one percent. It is intended that a general merchandise or non-pharmacy transaction will have a contribution in addition to the bank savings account contribution. An example of this would be a contribution by a telephone company (general merchandise) to the savings account based on a portion or percentage of the telephone use charge.

As previously discussed, it is also possible that the customer will be eligible for savings from sources that the bank is not aware of. In particular, a manufacturer may agree to provide a reimbursement to NPAX for customer purchases of a particular product. There are a number of reasons a manufacturer may agree to this, such as receiving customer demographics collected by NPAX from the customers who purchase the product. Reimbursement information is generally not known to the bank, but is known to NPAX. NPAX typically distributes and passes that reimbursement to individual customers through a bonus base points file that is sent to the bank.

At step 706, the bank implements the type of savings program that the customer has selected at NPAX, such as Use, Save, or Transfer.

If the customer has selected save or transfer, then at step 708 the bank determines if the customer has selected transfer, such as to a relative, and if so, then at step 710 the bank transfers the earned savings balance to the designated recipient, and updates the savings account balances of the customer and the designated recipient.

If the customer has selected use, then at step 712, the bank calculates any contributions to the savings account based on the current transaction and also compares the amount of the current transaction with the savings balance to determine whether there is sufficient balance to cover the current transaction.

If the balance is sufficient, then at step 714, the bank debits the customer savings account balance by the amount of the transaction. If the balance is not sufficient, then at step 716, the bank deducts the amount of the transaction from the customers credit or debit account.

The process illustrated in FIG. 7 allows a customer savings account balance to be used to fund transactions, such as by using the savings account balance to pay for prescriptions (use) or transfer savings to another (transfer) or accrue a savings balance (save).

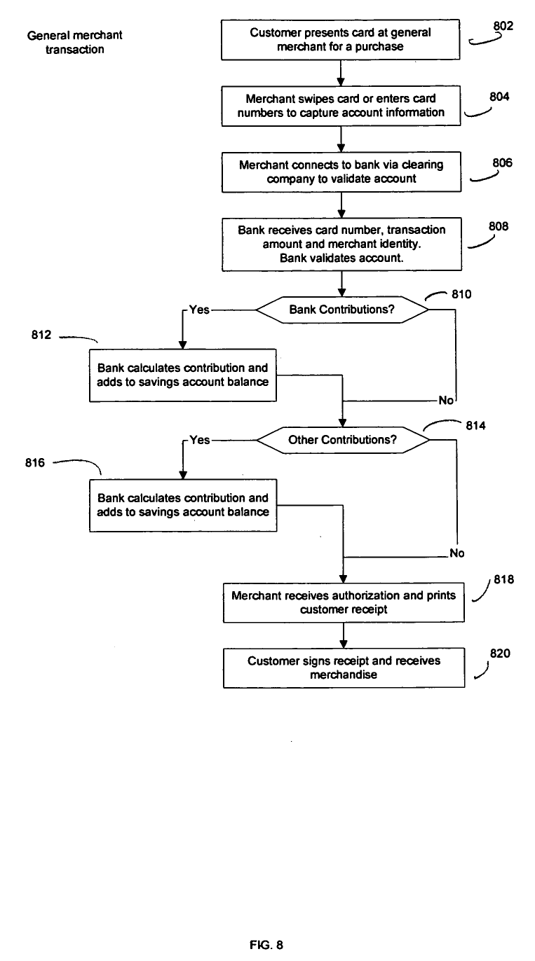

Referring to FIG. 8, a general merchandise transaction begins at step 802 with a customer presenting their card for purchase.

At step 804, the merchant swipes the card or enters the card numbers, with associated transaction information, typically the transaction amount. At step 806, the merchant connects to the bank, typically by a clearing company, to validate the transaction.

At step 808, the bank receives the card number, transaction amount and merchant identity. The bank uses this information to validate the transaction.

At step 810, the bank determines whether they provide savings account contributions, and if so, at step 812, determines the contribution amount and credits that amount to the account.

At step 814, the bank also determines whether there are other contributions, and if so, at step 816, determines the contribution amount and credits that amount to the account.

At step 818, the merchant receives authorization for the transaction from the bank, and at step 820. the customer signs a receipt for the transaction.

The steps illustrated in FIG. 8 are typical for a credit card, and it is understood that the steps for a debit card may differ somewhat.

In the description above, the bank creates individual customer savings accounts. It is also possible that the bank creates a single NPAX savings account and at the end of each month, there is a reconciliation with transfers to and from the NPAX savings account and individual customer accounts with the balances reflected in the monthly statement.

Although illustrative embodiments have been described herein in detail, it should be noted and will be appreciated by those skilled in the art that numerous variations may be made within the scope of this invention without departing from the principles of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

I claim:

1. A method for managing a patient prescription drug savings account, the method comprising:
receiving information related to a patient prescription transaction, the information including a prescribed drug;
identifying a contra-indication for the prescribed drug using information from at least one previous patient prescription transaction;
providing an alert based on the contra-indication; and
adjusting the patient prescription drug savings account balance using the information related to the patient prescription transaction.

2. A method according to claim 1, wherein information related to the patient prescription transaction is from a first pharmacy, and the information from at least one previous patient prescription transaction is from a second pharmacy.

3. A method according to claim 1, wherein information related to the patient prescription transaction is from a first pharmacy, and the information from at least one previous patient prescription transaction is from the first pharmacy.

4. A method according to claim 1, wherein identifying a contra-indication includes using patient information that is collected from multiple pharmacy transactions and stored in a database.

5. A system for managing a patient prescription drug savings account, the system comprising:
means for receiving information related to a patient prescription transaction, the information including a prescribed drug;
means for identifying a contra-indication for the prescribed drug using information from at least one previous patient prescription transaction;
means for providing an alert based on the contra-indication; and
means for adjusting the patient prescription drug savings account balance using the information related to the patient prescription transaction.

6. A system according to claim 5, wherein information related to the patient prescription transaction is from a first pharmacy, and the information from at least one previous patient prescription transaction is from a second pharmacy.

7. A system according to claim 5, wherein information related to the patient prescription transaction is from a first pharmacy, and the information from at least one previous patient prescription transaction is from the first pharmacy.

8. A system according to claim 5, wherein means for identifying a contra-indication includes means for using patient information that is collected from multiple pharmacy transactions and stored in a database.

9. A computer readable medium with software code stored thereon for managing a patient prescription drug savings account, the medium comprising:
code to receive information related to a patient prescription transaction, the information including a prescribed drug;
code to identify a contra-indication for the prescribed drug using information from at least one previous patient prescription transaction;
code to provide an alert based on the contra-indication; and
code to adjust the patient prescription drug savings account balance using the information related to the patient prescription transaction.

10. A computer medium according to claim 9, wherein information related to the patient prescription transaction is from a first pharmacy, and the information from at least one previous patient prescription transaction is from a second pharmacy.

11. A computer medium according to claim 9, wherein information related to the patient prescription transaction is from a first pharmacy, and the information from at least one previous patient prescription transaction is from the first pharmacy.

12. A computer medium according to claim 9, wherein code to identify a contra-indication includes code to use patient information that is collected from multiple pharmacy transactions and stored in a database.

13. A programmed computer for managing a patient prescription drug savings account, comprising:
a memory having at least one region for storing computer executable program code; and
a processor for executing the program code stored in the memory; wherein the program code comprises:
code to receive information related to a patient prescription transaction, the information including a prescribed drug;
code to identify a contra-indication for the prescribed drug using information from at least one previous patient prescription transaction;
code to provide an alert based on the contra-indication; and
code to adjust the patient prescription drug savings account balance using the information related to the patient prescription transaction.

14. A programmed computer according to claim 13, wherein information related to the patient prescription transaction is from a first pharmacy, and the information from at least one previous patient prescription transaction is from a second pharmacy.

15. A programmed computer according to claim 13, wherein information related to the patient prescription transaction is from a first pharmacy, and the information from at least one previous patient prescription transaction is from the first pharmacy.

16. A programmed computer according to claim 13, wherein code to identify a contra-indication includes code to use patient information that is collected from multiple pharmacy transactions and stored in a database.

17. A method for managing a patient prescription drug savings account, the method comprising:
receiving information related to a patient prescription transaction, the information including transaction cost and prescribed drug information;
sending patient identification information and the prescribed drug information to a benefits carrier;
receiving co-payment information from the benefits carrier, the co-payment information including a covered amount;
calculating a remaining amount owed using the transaction cost and the co-payment information;
calculating a savings account adjustment using the remaining amount owed; and
adjusting the patient prescription drug savings account balance using the calculated adjustment.

18. A method according to claim 17, wherein adjusting is a contribution to the savings account.

19. A method according to claim 17, wherein adjusting is a deduction from the savings account.

20. A system for managing a patient prescription drug savings account, the system comprising:
means for receiving information related to a patient prescription transaction, the information including transaction cost and prescribed drug information;
means for sending patient identification information and the prescribed drug information to a benefits carrier;
means for receiving co-payment information from the benefits carrier, the co-payment information including a covered amount;
means for calculating a remaining amount owed using the transaction cost and the co-payment information;
means for calculating a savings account adjustment using the remaining amount owed; and
means for adjusting the patient prescription drug savings account balance using the calculated adjustment.

21. A system according to claim 20, wherein adjusting is a contribution to the savings account.

22. A method according to claim 20, wherein adjusting is a deduction from the savings account.

23. A computer readable medium with software code stored thereon for managing a patient prescription drug savings account, the medium comprising:
code to receive information related to a patient prescription transaction, the information including transaction cost and prescribed drug information;
code to send patient identification information and the prescribed drug information to a benefits carrier;
code to receive co-payment information from the benefits carrier, the co-payment information including a covered amount;
code to calculate a remaining amount owed using the transaction cost and the co-payment information;
code to calculate a savings account adjustment using the remaining amount owed; and
code to adjust the patient prescription drug savings account balance using the calculated adjustment.

24. A computer medium according to claim 23, wherein adjusting is a contribution to the savings account.

25. A computer medium according to claim 23, wherein adjusting is a deduction from the savings account.

26. A programmed computer for managing a patient prescription drug savings account, comprising:
a memory having at least one region for storing computer executable program code; and
a processor for executing the program code stored in the memory; wherein the program code comprises:
code to receive information related to a patient prescription transaction, the information including transaction cost and prescribed drug information;
code to send patient identification information and the prescribed drug information to a benefits carrier;
code to receive co-payment information from the benefits carrier, the co-payment information including a covered amount;
code to calculate a remaining amount owed using the transaction cost and the co-payment information;
code to calculate a savings account adjustment using the remaining amount owed; and
code to adjust the patient prescription drug savings account balance using the calculated adjustment.

27. A programmed computer according to claim 26, wherein adjusting is a contribution to the savings account.

28. A programmed computer according to claim 26, wherein adjusting is a deduction from the savings account.

29. A method for managing patient prescription drug savings accounts, the method comprising:
issuing a patient prescription drug product card, the product card having an associated patient prescription drug savings account;
receiving information related to a patient prescription transaction, the information including prescribed drug information and product card information;
identifying a first patient prescription drug savings account using the product card information;
adjusting the first patient prescription drug savings account balance using the information related to the patient prescription transaction; and
transferring a portion of the first patient prescription drug savings account balance to a second patient prescription drug savings account balance.

30. A method according to claim 29, further comprising:
receiving a manufacturer contribution for the prescribed drug; and
adjusting the first patient prescription drug savings account balance using the manufacturer contribution.

31. A system for managing patient prescription drug savings accounts, the system comprising:
means for issuing a patient prescription drug product card, the product card having an associated patient prescription drug savings account;
means for receiving information related to a patient prescription transaction, the information including prescribed drug information and product card information;
means for identifying a first patient prescription drug savings account using the product card information;
means for adjusting the first patient prescription drug savings account balance using the information related to the patient prescription transaction; and
means for transferring a portion of the first patient prescription drug savings account balance to a second patient prescription drug savings account balance.

32. A system according to claim 31, further comprising:
means for receiving a manufacturer contribution for the prescribed drug; and
means for adjusting the first patient prescription drug savings account balance using the manufacturer contribution.

33. A computer readable medium with computer software code stored thereon for managing patient prescription drug savings accounts, the medium comprising:
code to issue a patient prescription drug product card, the product card having an associated patient prescription drug savings account;
code to receive information related to a patient prescription transaction, the information including prescribed drug information and product card information;
code to identify a first patient prescription drug savings account using the product card information;
code to adjust the first patient prescription drug savings account balance using the information related to the patient prescription transaction; and
code to transfer a portion of the first patient prescription drug savings account balance to a second patient prescription drug savings account balance.

34. A computer medium according to claim 33, further comprising:
code to receive a manufacturer contribution for the prescribed drug; and
code to adjust the first patient prescription drug savings account balance using the manufacturer contribution.

35. A programmed computer for managing a patient prescription drug savings account, comprising:
a memory having at least one region for storing computer executable program code; and
a processor for executing the program code stored in the memory; wherein the program code comprises:
code to issue a patient prescription drug product card, the product card having an associated patient prescription drug savings account;
code to receive information related to a patient prescription transaction, the information including prescribed drug information and product card information;
code to identify a first patient prescription drug savings account using the product card information;
code to adjust the first patient prescription drug savings account balance using the information related to the patient prescription transaction; and
code to transfer a portion of the first patient prescription drug savings account balance to a second patient prescription drug savings account balance.

36. A programmed computer according to claim 35, further comprising:
code to receive a manufacturer contribution for the prescribed drug; and
code to adjust the first patient prescription drug savings account balance using the manufacturer contribution.
